(19) United States
(12) Patent Application Publication
(10) Pub. No.: US 2010/0216964 A1
(43) Pub. Date: Aug. 26, 2010

(54) METHOD FOR PRODUCING ARYL-ARYL COUPLED COMPOUNDS

(75) Inventors: Torsten Zech, Heidelberg (DE); Gunilla Kaiser, Leimen (DE); Oliver Koechel, Bubenheim (DE); Oliver Laus, Mannheim (DE); Denis Huertgen, Heppenheim (DE)

Correspondence Address: THE FIRM OF HUESCHEN AND SAGE, SEVENTH FLOOR, KALAMAZOO BUILDING, 107 WEST MICHIGAN AVENUE, KALAMAZOO, MI, 49007, US

(73) Assignee: HTE AKTIENGESELLSCHAFT THE HIGH THROUGHPUT EXPERIMENTATION COMPANY, Heidelberg (DE)

(21) Appl. No.: 12/085,497

(22) PCT Filed: Nov. 22, 2006
(86) PCT No.: PCT/EP2006/011202

§ 371 Date: Dec. 15, 2009

(30) Foreign Application Priority Data
Nov. 23, 2005 (DE) 10 2005 055 866.6

(51) Int. Cl. C08G 61/02

(52) U.S. Cl. 528/8

(57) ABSTRACT

The invention relates to a method for producing aryl-aryl coupled compounds. The method is continuous, at least two non-miscible phases (M01) and (B01) being optionally first blended in a mixer (020). The reaction is then carried out continuously in a fixed-bed reactor (030) and subsequently an optional online analysis (060) of the products (P01) takes place.

The present invention relates to a novel method for the manufacture of aryl-aryl coupled compounds.

The manufacture of aryl-aryl coupled compounds is of high economical and technical interest both in the fields of pharmaceutical chemicals and agrochemicals and in the field of optoelectronics. With regard to optoelectronic applications, exemplarily the use of aryl-aryl coupled compounds as organic semiconductors, organic solar cells or liquid crystals is to be mentioned.

The purity of aryl-aryl coupled compounds is of central importance for the mentioned applications as well as for further applications. In particular in producing higher molecular compounds, in particular polymers, purification is often very complex and thereby cost-intensive. For the manufacture of polymers it is necessary to obtain these with precisely specified average molecular weights, whereby often also the molecular weight distribution is to be kept in narrow limits. Deviations from the aim with regard to product purity and to the physical and chemical properties may result in that the compounds cannot be used for the intended applications.

The principle of coupling reactions for the manufacture of aryl-aryl compounds is known for any length of time. As an example for the synthesis of aryl-aryl coupled compounds, the Suzuki-coupling has to be mentioned [Synthetic Communications, 11 (7) (1981) 513]. This is the coupling of aromatic compounds that have a halide respectively a sulfone oxy-function, with aromatic compounds, which have a boric acid group (hetero-coupling). In the process, the reaction is carried out in liquid phase under catalytic action of a Pd-containing catalyst in connection with the activation by means of a base.

In several scientific publications relating to coupling reactions between two different organic aromatic molecules, coupling reactions by means of a continuous process are described. Basheer et al. [Tetrahedron Letters 45 (2004) 7297-7300] describe the realization of Suzuki-coupling reactions for the linkage of two aromatic compounds, respectively, for the manufacture of biphenyls at Pd-containing nanoparticles. Thereby, the reactions are carried out in a particular capillary microreactor.

Lee et al. [Chem. Commun, 2005, 2175-2177] describe Suzuki-coupling reactions for the linkage of two different mononuclear aromatic compounds, respectively, for the manufacture of biphenyl compounds by using a specific Pd-containing catalyst, wherein Pd is embedded in polyurethane capsules. Thereby, the coupling reaction inter alia is carried out in a continuous method via a HPLC-column, which is filled with the polymer catalyst.

He et al. [Appl. Catal. A: Gen., 274 (2004), 111-114] describe Suzuki-coupling reactions for the linkage of mononuclear aromatic compounds for the manufacture of biphenyl compounds, which are carried out by means of a continuous process in a capillary reactor by using oxidic catalysts which are loaded with Pd.

As drawback of the before-mentioned known continuous processes for the (hetero)coupling is to be mentioned that during the reaction within the (capillary) reactor only small quantities of educt/educts can be reacted and that the process control is restricted to low molecular organic compounds, and cannot be transferred offhand to polymerization reactions, in particular not to those polymerization reactions which are intended to result in high molecular weights. Furthermore, in the reactors that are described in this prior art, poly-phase reactions cannot be carried out or can only be carried out in a bad manner.

One application of coupling reactions for polymerization is described in WO 03/048225. The disclosure of WO 03/048225 thereby is restricted to a non-continuous batch mode in a stirred tank reactor. Thereby, a two-phase reaction control (liquid phase with base, organic phase with aryl compounds) is described. A drawback of the manufacturing process, which is described in WO 03/048225 are the batch-to-batch variations necessarily occurring within the batch mode. This particularly applies to polymerization reactions in which at the end of the reaction a strong exponential increase of the chain length can occur, which can only be difficultly controlled in the batch mode. Also, an influence of a once started reaction is only difficultly possible.

Thus, one object of the present invention is to provide a method for the manufacture of coupled organic compounds, preferably of (hetero)aryl-(hetero)aryl-C—C-bonds, preferably of polymers with such bonds, which allows an improved process control, control of the end products and reproducibility against the prior art. Another object is to develop these methods more cost-effective and more carefully with respect to resources as is possible with the methods of the prior art.

This object as well as further objects are thereby solved that a method is provided in which the aryl-aryl coupling is carried out in an improved continuous process Surprisingly, it was found in the scope of experiments (see Examples) that the continuous working capillary reactor as is known for coupling reactions of low molecular organic compounds is restricted with respect to the mass transfer between the two non-miscible phases. This limitation of the continuous process can be overcome by the use of a fixed bed reactor (FBR). This FBR thereby has the advantage of a continuous reactor, i.e., it particularly allows the online-control of the products.

Thereby, the method according to the invention for the continuous reaction of at least two liquid (educt-)phases that are not miscible with each other, preferably comprises the following steps:
(i) combining at least two liquid phases that are not miscible with each other, in a defined relative ratio of quantity;
(iii) feeding the mixture from (i), or from a step following step (i), into a fixed bed reactor, which is flowed through by this mixture for a determined residence time at a defined temperature.

Preferably, the combining in step (i) occurs in a mixing point. Further preferably this mixing point is characterized in that by leaving this mixing point said at least two non-miscible phases are present in a capillary as “packets” or as “droplets” having a characteristical parameter (length, diameter) that is not more than thrice as high as the capillary diameter, preferably not more than twice as high, further preferred not more than just as high (for exemplary “packets” of two non-miscible phases: see FIG. 7). Thereby, also a phase mixing on macroscopic or microscopic level can occur which cannot be recognized with the naked eye.

Each liquid phase can contain an arbitrary number of components in dissolved or in partially dissolved form.

In a preferred embodiment, step (ii) can be carried out between steps (i) and (iii):
(ii) feeding the mixture from (i) to a mixer in which a mixing of said at least two liquid non-miscible phases takes place.

The preferred mixer is a micro-mixer.

In another preferred embodiment, optionally step (iv) is carried out after step (iii):
(iv) feeding at least one phase of the at least two phases effusing from the fixed bed reactor from (iii) to a device for online analysis; optionally under metering a solvent.

The term “non-miscible” in the context of the present application means that the two phases can be partially mixable, however not completely. As long as two separated liquid phases can be observed in the equilibrium, these phases have to be considered as “non-miscible”. Each liquid phase can contain an arbitrary number of dissolved components.

A “fixed bed reactor” in the context of the present invention is any reactor which has at least one means for the mass transfer between two phases, i.e., improves the mass transfer between two phases, in particular between two liquid phases compared to an empty reactor, in particular compared to an empty tube. For this, any means known to the person skilled in the art can be applied, for example plates, coatings, honeycombs, channels, and the like. A special type of a fixed bed reactor in the context of the present invention is a bulk materials reactor containing a bulk of particles, preferably of spherical particles having a diameter of from 1 μm to 2,000 μm, preferably from 50 μm to 500 μm.

In a preferred embodiment, the fixed bed reactor is designed such that after the outlet of the fixed bed reactor the at least two non-miscible phases, which emanate from the reactor, are present in a capillary in the form of separated packets in a length that is not more than thrice as high as the capillary diameter, preferably not as twice as high, further preferred not more than just as high as the capillary diameter (see FIG. 7).

Without wishing to bind the invention to a certain mechanism, the FBR should be designed such that it contributes for the intensifying of the mass transfer between the two non-miscible liquid phases.

Preferably, the fixed bed reactor is in the form of a tube. A FBR in the context of the present invention has at least one inlet and at least one outlet.

In a preferred embodiment of the present invention, the operation and the control of the whole equipment including the process data collection is at least partially, preferably also predominantly or also completely automated. Such an automation in this scope is considerably more difficult for processes in the batch mode.

In a preferred embodiment, for the control of the fluid feeds mass flow controllers are applied.

In a further preferred embodiment it is possible to conduct a pressure adjustment by means of a pressure controller which is provided downstream of the reactor outlet, so that the pressure in the FBR is above normal pressure. Thereby, also reactions can be carried out at temperatures which are above the boiling point/the boiling points of the solvent and/or reactants respectively mixtures. A boiling of individual components in the bulk materials reactor is thus effectively prevented. This is an advantageous embodiment, because during boiling the formation of gas bubbles can occur and therewith the demixing of individual reaction components, whereby the two non-miscible phases, in particular the organic and aqueous phases, may be separate from each other.

For the mass transport in the context of the method according to the invention it is preferred that suitable conveying means—such as pumps or application of pressure—are applied, with the aid of which the starting components, for example the two liquid, non-miscible phases, are fed into the mixer preferably via a piping, respectively are directly fed or are fed from the mixer into the reactor.

For the transport of the liquids for example HPLC pumps are suitable. For larger trials it is possible to transport the dissolved starting components respectively the liquid phases by means of larger and/or other pumps through the pipes. Thereby, the flow rates of the individual educt feeds have to be controlled as precise as possible. For this, for example the use of preparative HPLC pumps is preferred. In a preferred embodiment, for example for the transport of at least one educt, high-pressure pumps are applied, preferably piston pumps, which allow a precisely determinable flow rate (preferably with a deviation of 0.3% or less). Further preferred at least two separated piston pumps having a relative deviation in the flow rate of 0.3%, respectively, or less are employed for the feed of at least two monomers.

Preferably, the temporary and spatial changes of the mass feeds in the present continuous operation are preferably minimized. Steady conditions are in particular then adjustable if the optimal observed reaction conditions were found for the respective reaction, for example in pre-experiments. When using mass flow controllers for the operation respectively control, the liquid feeds are preferably moved through the piping of the device by means of application of pressure.

It is an advantage of the continuous method of the invention that at first solvent can be rinsed through the whole device in order to remove oxygen from the device or to clean the device from other impurities.

Preferably, the method according to the invention is carried out under inert conditions, i.e., under conditions, in which the presence of oxygen is largely or possibly completely excluded. This is inter alia thereby ensured that the liquid, non-miscible phases are inerted with the individual starting components prior to the start of the method according to the known methods. This can preferably take place by means of conducting inert gases such as argon, helium or nitrogen through the solutions, or by means of a treatment with ultrasonic.

In a preferred embodiment, the method according to the invention is used for at least one coupling reaction between at least two (hetero)aryl-compounds (i.e., aryl-aryl, aryl-heteroaryl, heteroarly-heteroaryl).

Further preferred is a method for the reaction of a halide or sulfonyl oxy-functionalized aryl or heteroaryl compound with an aromatic or heteroaromatic boron compound, preferably in the presence of a catalyst as well as in the presence of a base and a solvent or a solvent mixture by forming an aryl-aryl respectively aryl-heteroaryl or heteroaroyl-heteroaryl-C—C bond.

As an example of such a coupling reaction, the Suzuki-coupling is mentioned.

In the context of the present invention, a multi-step synthesis by using at least two monomers, which preferably results in block polymers respectively block-copolymers, is preferred.

In another preferred embodiment, as starting components monomers are applied which are present in a liquid phase, which then react in a multitude of coupling reactions to polymers.

Preferably—in case that the reactions carried out in the FBR are polymerization reactions—the different monomers, which take part in the reaction, are commonly provided in liquid phase.

Since the process according to the invention is a continuous process, it proves superior against the batch processes used until now in the field of synthesis of polymeric compounds. This is particularly due to the improved process operation and optimization of the operation of the method as a result of the downstream online chemical analysis. Thus, for example, a rapid increase of the molecular weight can be immediately realized, and the reaction conditions may be adjusted, if necessary.

However, the present invention is not limited to the realization of polymerization reactions. In particular, the method according to the invention is also suitable for the organic synthesis of small molecules.

In a preferred embodiment, the educts are combined in a series connection of static mixers by using optional step (ii). Preferably, micro-mixers are used for this. It is possible to carry out the mixing process sequentially. Preferably, also for the mixing process pre-determined sequences are kept in mind which, for example, consist therein that, as a rule, at first the monomers are mixed with the base, and in the next step the homogeneous catalyst is fed, which is optionally used.

In place of the (micro-)mixer of step (ii), or additionally to this, also in step (i) the above-described mixing point of the pre-mixture can be used. Preferably, the mixing point is characterized by a low flow diameter, a low dead volume or a low internal volume. All this contributes to the mass exchange and counteracts the phase separation.

Preferably, static micro-mixers are used as mixers. These contain no movable parts. Thereby, the fluids to be mixed are at first partitioned by a suitable arrangement of micro-channels into a huge amount of partial volume flows, and are subsequently brought into an intimate contact with each other. Consequently, said fluids are preferably mixed in a diffusive manner.

For example, mixers from IMM (Institute for Microtechnology Mainz) can be applied as micro-mixers. Micro-mixers are characterized in that they also allow the mixing of volumes in the milliliter range, preferably in the microliter range. If micro-channels are applied, these then have a diameter of less than one mm, preferably of less than 500 μm.

Preferred used mixers are pressure resistant under the used reaction conditions and are inert in contact with the employed chemicals. Stainless steel is the preferred material for a mixer.

In a preferred embodiment, (micro-)mixers as well as receivers and pump heads are tempered by means of heating or cooling devices.

If, in a preferred embodiment, step (ii) is preceding step (iii), then the device has mixer and FBR. With regard to the geometric design of the complete device comprising mixer and at least one FBR, it is preferred that the device has a low dead volume, i.e., a low volume between mixer and FBR, low flow diameters as well as high flow rates between mixer and FBR. These measures counteract a phase separation. The multi-phase flow, which is generated in the micro-mixers can be demixed by means of the phase separation, what is, as a rule, not desired. It is preferred that the multi-phase flow generated in the (micro-)mixers is transferred into the FBR wherein separation should be as low as possible. If pipes are used between mixer and reactor, then these pipes preferably have a diameter of from 0.1 to 2 mm, further preferred between 0.5 and 1 mm. Preferably, the pipes are capillaries.

In this context it is also conceivable that direct combination between mixer and FBR is present in one assembly, what in turn can be particularly advantageous in order to exclude the separation of the multi-phase flow as far as possible. In this context it is also preferred that FBR and mixer are spatially as close as possible.

The sequence in which the individual components of the liquid phases respectively the liquid phases as such are mixed (with each other) is important in order to avoid undesired reactions between the different educt components. Thus, it can be preferred that a multi-step mixing method is carried out in which at first several two-component mixtures are generated, which are subsequently combined. In an alternative for this, at the start a one-step multi-component mixture of all components in at least one of the at least two liquid phases can be realized.

In context with the FBR used in step (iii) of the method, the following embodiments are preferred:

Contrary to a capillary reactor, a continuously working FBR allows that the mass transport between the involved liquid phases in the flow through a suitable embodiment of a fixed bed can be intensified. Thereby, the FBR provides a significant contribution for the mixing of the multi-phase flows, which thereby can react due to the improved reaction conditions. The two-phase flow, which circulates around the particles, results in a steady renewal of the interface between the two non-miscible phases.

In a preferred embodiment of the method according to the invention—in a particularly simple embodiment—the components can be applied which are known from HPLC chromatography.

Preferably, the reactors are tube-shaped and have an inner diameter being in the range of from 1 to 50 mm, preferably in a range of from 1 to 20 mm; further preferred is a range of from 1 to 10 mm. Altogether, the inner diameters of the employed reactors are preferably larger than those ones of the capillary reactors being described in the literature.

In the context of the present invention, it is preferred that two or more (fixed bed) reactors are connected in series in order to increase thereby the residence time of the educts respectively of the educt within the reactor. Thereby, in each reactor different residence times can be realized, respectively, for example by different dimensioning (diameter, length, etc.). Thereby, in the individual reactors the same or different temperatures can be adjusted.

The residence times (RT) of individual volume segments of the mass flow within the FBR preferably are between 1 and 150 min, further preferably between 1 and 60 min, further preferred between 1 and 30 min. Thereby, the residence time is the time in which, for example, a defined volume of liquid “resides” in the reactor. The RT is calculated from the ratio of the reaction volume and the fed volume feed.

Particle sizes for the particle bed which is preferably used for the promotion of the mass exchange are in a range of from 1 μm to 2,000 μm, preferably in a range of from 50 to 500 μm, further preferred in a range of from 150 to 300 μm. A slightly higher average particle size is not disclaimed, in particular if the method is carried out, for example, at higher flow rates.

For the manufacture of the fixed bed of a fixed bed reactor or a bulk materials reactor any material in any geometrical form is suitable, which contributes in a multi-phase flow, in particular in a two-phase flow, for the formation/enlargement of the interface between these phases. Preferred are materials such as glass, ceramics, steatite, alumina, silica, oxides of refractory metals such as, in particular, titanium oxide, zirconia. These materials may be porous or non-porous, and may be impregnated and/or coated with metal salt solutions.

Besides oxidic materials, the following inert materials are preferred as fixed bed materials: PTFE, PEEK, charcoal, glassy carbon, graphite, etc. Further preferred as bulk materials are metal particles, in particular made from titanium or stainless steel. As further non-oxidic materials carbides and nitrides are mentioned, in particular SiC, SiN, TiC or TiN. Monoliths or foams of the before-mentioned materials are preferred.

It is further preferred that the bed materials have pores, preferably pores having defined pore size respectively having a (hydraulic) diameter in the range of from 1 to 2,000 μm, preferably of from 10 to 500 μm.

The hydraulic diameter dₕ is the ratio of the fourfold flow diameter A and the circumference U of a measure diameter which is wetted by the fluid: dₕ=4·A/U. The hydraulic diameter of particles in a reactor having an inner diameter of 40 cm is approximately 1.7 μm, for particles having a diameter of 10 μm, and 0.045 μm for particles having a diameter of 1 μm. If the particle diameter is 2 mm, then the hydraulic diameter of the particles in a reactor having an inner diameter of 40 cm is 330 μm. In a reactor having an inner diameter of 2 cm and particles having a diameter of 100 μm, the hydraulic diameter is 0.15 μm.

All in all each fixed bed can be present as a bed of particles, as foam or as frit.

The bulk material/fixed bed can be pre-treated, in particular can be rinsed and screened. A bulk material having particles can be particularly well purified by means of rinsing with hot solvent, and can be exempted from particulate matter. This is particularly facilitated by the continuous operation.

The FBR can be arranged in any space direction. In a preferred embodiment, however, the FBR is vertically arranged so that the fluid flow may flow through the reactor from top-down (“down-flow”) or also from bottom-up (“up-flow”). Preferably, the method is carried out such that the reactor is flowed through from the bottom-up (“up-flow”). The “up-flow” operation has the advantage that—contrary to the “down-flow” operation—the liquid phases cannot “trickle through” the reactor and therewith leave parts of the fixed bed “dry”. All in all, the “up-flow” operation reduces the danger of a phase separation.

Preferably, the reaction temperature is in a range of from 20 to 180° C.; further preferred, the method is carried out in a temperature range of from 60 to 150° C. and further preferred in a range of from 80 to 120° C. For the heating of the reactor respectively also for the heating of the mixer/the mixers as well as the entire device, in principle all common methods can be applied. Exemplarily, here the following heating methods are mentioned: electric, in particular in cascade control; by radiation, in particular microwaves or IR-radiation; fluidic, in particular by heat exchange with steam, water, oils, etc.

A characteristic feature of the tube-shaped FBR being preferably applied in the method is given by the ratio of the length of the reactor and the diameter thereof (i.e., UD-ratio). In a preferred embodiment, the reactor being used for the method has a UD-ratio that is in the range of from 10:1 to 200:1.

A further characteristic feature for the method of the invention is the ratio of particle size and diameter of the reactor (i.e., the P/D-ratio). Thereby it is preferred that the P/D-ratio is in a range of from 1:5 to 1:200.

A width as low as possible of the particle size distribution of the particles of the bed of the fixed bed reactor is preferred because therewith a more favourable and more uniform residence time distribution of the fluid flow can be realized.

Purely in principle, the method of the invention can be carried out in a pressure range ranging from 1 to 50 bar. Preferably, however, the pressure is in a range of from 1 to 10 bar and further preferred in a range of from 1 to 5 bar.

According to a preferred embodiment of the present invention, a flow control of the individual educt flows is possible. Also conceivable is a regulation of flow and temperature as result of the data, which are gained by means of the online chemical analysis by feed-back.

Online chemical analysis in the context of the present invention is any method of analysis, which allows to analytically determine at least one chemical and/or physical property of at least one product from the FBR. This analysis should allow obtaining information regarding the status of the reaction and should allow exerting influence on the reaction. Such a feed-back between analysis and reaction control is usually not possible for batch methods.

The use of an analytical method by means of which the reaction products can be directly characterized online is a preferred aspect of the method of the invention. To the methods for online analysis in the context of the present invention also counts the continuous sampling. As a preferred analysis method for polymers, gel permeation chromatography (GPC) is applied.

Prior to the GPC analysis, as the case may be, the degassing of the sample is necessary. As the case may be, it is advantageous to effect the stop of the reaction by means of an appropriate tempering of the product flow. A dilution of the sample with solvent is possible, for example to a ratio of sample to solvent of 1:100.

In a preferred embodiment, small sample quantities are employed. GPC is preferably carried out such that the water phase needs not to be separated prior to the analysis, however, can be co-injected when using an appropriate column.

The analysis path can be sequentially tempered or can be completely tempered. Optionally, also prior to the realization of the analytical determination, a phase separation can be carried out.

Further exemplary methods for online analysis are: FT-IR (Fourier Transform Infrared Spectroscopy), preferably with ATR-crystal (flow cell), for determining conversion by means of selected bands of functional groups of the monomers, light scattering, UV-VIS-spectroscopy or measurement of viscosity. The before-mentioned measurement methods, however, possibly may have the draw-back against GPC that a calibration may be necessary for each new reaction mixture. Preferably, FT-IR is employed in order to control the conversion of functional groups, in particular also online during the reaction course.

Further preferred embodiments of the method of the invention at least comprise one of the following further steps: (a) heating the reactor, preferably stepwise heating the reactor, further preferred in different heating zones along the flow direction with different temperature; (b) reaction stop by cooling after the reactor outlet; (c) addition of “endcappers” after the reactor outlet; (d) addition of solvent for reducing viscosity after the reactor outlet; (e) addition of further monomers after each reactor section; (f) series connection of several reactors; (g) parallel connection of several reactors for increasing the throughput.

In the context of the present invention, “endcappers” are molecules or substances, which effect the termination of the chain propagation or the polymerization. Preferably, the endcappers of the invention are monofunctional. Further preferred, the use of endcappers limits the maximal achievable molecular weight of the polymer, which is obtained as product. In a preferred embodiment of the method of the invention, at least one type of endcappers is already provided on the educt side within the reactor in order to regulate respectively to limit the molecular weight, which is achieved at the end of the reaction.

As solvent for the non-aqueous (organic) phase, preferably dioxane, toluene or THF or mixtures thereof are applied. The use of THF is particularly preferred because the phase contact is improved by means of THF. Mixtures in an approximate quantity ratio dioxane:toluene:THF=1:1:1 are particularly preferred.

No restriction exists with regard to the monomers, which are applied as educts according to the invention. Each monomer thereby can also be a mixture of at least two different monomers. Thereby, the monomers of the mixture can differ from each other with respect to their functional group and/or their other structure. Preferably, the stoichiometry of different functional groups is adjusted, for example 50:50.

### BRIEF DESCRIPTION OF THE FIGURES

FIG. 1 shows a flow-chart with the basic scheme of the method of the invention (see list of reference numerals at the end of the Examples);

FIG. 2 shows a flow-chart with a more complex scheme of the method of the invention (see list of reference numerals at the end of the Examples);

FIG. 3 shows a flow-chart with a serial arrangement of fixed bed reactors and with stepwise feed of the monomer (see list with reference numerals at the end of the Examples);

FIG. 4 shows a schematic illustration of an embodiment of a reactor as is used in the method of the invention;

FIG. 5 shows experimental results obtained for a polymerization reaction, which was carried out in a batch reactor; the y-axis indicates the averaged molecular weight of the polymerization reaction, and the x-axis indicates the reaction time;

FIG. 6 shows experimental results, which were obtained by means of the continuous method by using a capillary reactor (B, C) and the FBR (A) of the invention; the y-axis indicates the averaged molecular weight of the polymerization reaction and the x-axis indicates the reaction time;

FIG. 7 is a photographic illustration of the capillary flow at the outlet of a FBR of the invention during the realization of a polymerization experiment according to the invention;

FIG. 8 shows results of rapid GPC as evidence that in the FBR of the invention online chemical analysis (approximately having a period of 5 min) is possible with the same quality as with conventional GPC (approximately 30 min);

FIG. 9 shows the molecular weight of the polymer product in dependence of the residence time for a capillary reactor having no bed according to the invention and having a long residence time;

FIG. 10 shows the molecular weight of the polymer product as it emanates from a reactor according to the invention having a fixed bed in continuous operation at the reactor outlet, and namely in dependence from the passed time;

FIG. 11 shows the flow-chart of an assembly of three continuously operated reactors having a fixed bed with bulk materials, and which are connected in series;

FIG. 12 shows the flow-chart of an assembly of four continuously operated capillary reactors which are connected in series, each of them having a fixed bed with bulk materials;

FIG. 13 shows a particularly multi-functionally applicable device of five fixed bed reactors connected in series, which can be continuously operated and which, in the embodiment that is shown in this figure, allows the manufacture of block polymers;

FIG. 14 shows the flow-chart for a device being suitable for the sequential synthesis of different polymers, and which comprises a set of two monomer receivers having four different monomers, respectively, from which selectively different polymer products can be synthesized by means of the aid of the method according to the invention, and which can be analyzed with respect to their properties.

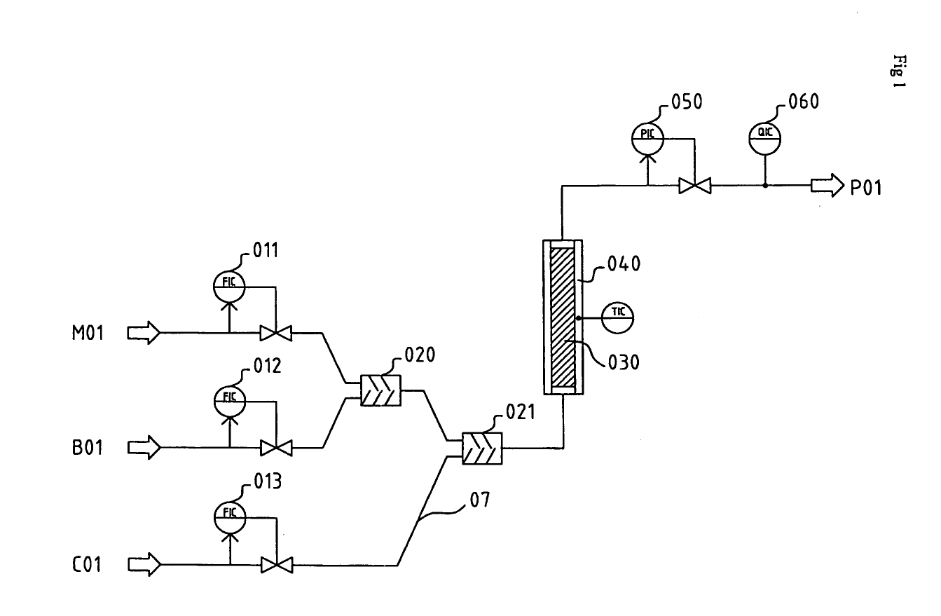

FIG. 1 shows a basic realization of the method according to the invention. Monomer M1 and base B1 are combined in a micro-mixer (020) and are mixed. A catalyst (C1) is admixed in a further micro-mixer (021). This premixed mixture arrives from bottom, that is against the gravitation into the fixed bed reactor (030). The product emanating from the outlet is conducted to the device for the online chemical analysis (060), (061) (the complete list of reference numerals is printed at the end of the Examples).

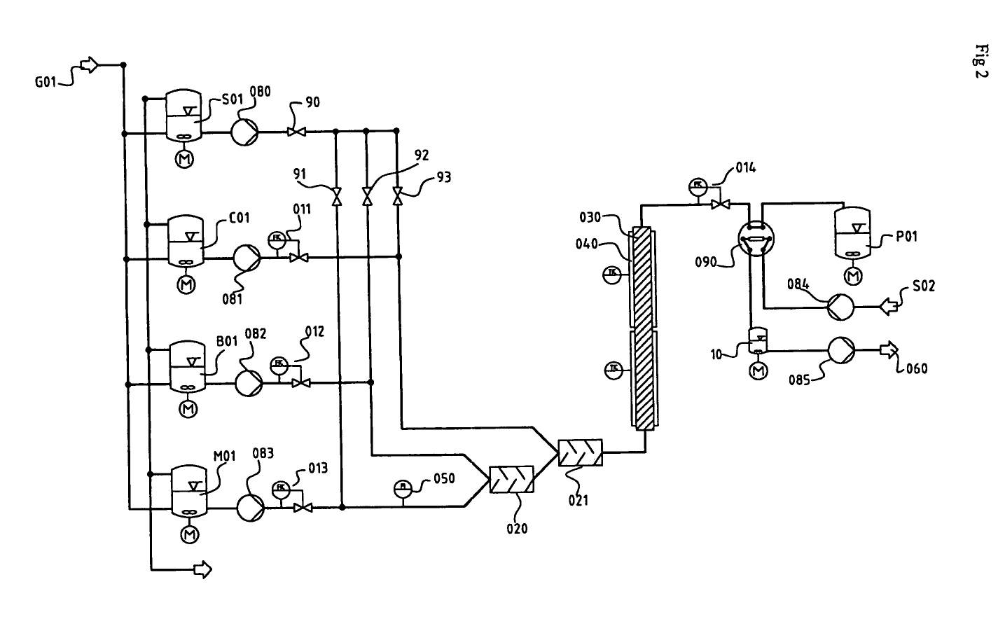

FIG. 2 shows a more complex realization of the method of the invention. At the outlet of the fixed bed reactor (030), the product flow is transported via a multiport valve (090) alternatively into a product collecting receiver or to a device for the online chemical analysis (060). The multiport valve (090) is provided with a sample loop (without reference numeral) and a solvent feed. Thereby, for example, it is possible to take a defined amount of the sample from the product feed and to subsequently transport this sample together with solvent (S02) via a mixer (10) into the analysis unit (060), whereby for the transport of the solvent respectively the mixture of solvent/sample mixture pump (084) and pump (85) are used. In doing this, the sample from the polymer product flow P1 can be directly transferred into the dilution degree being required for the analysis which, for example, is necessary for GPC analysis. The collecting receiver for the polymer product (P1), which is presented in the figure without reference numerals, can also—as presented in FIG. 2—be provided with a stirring system.

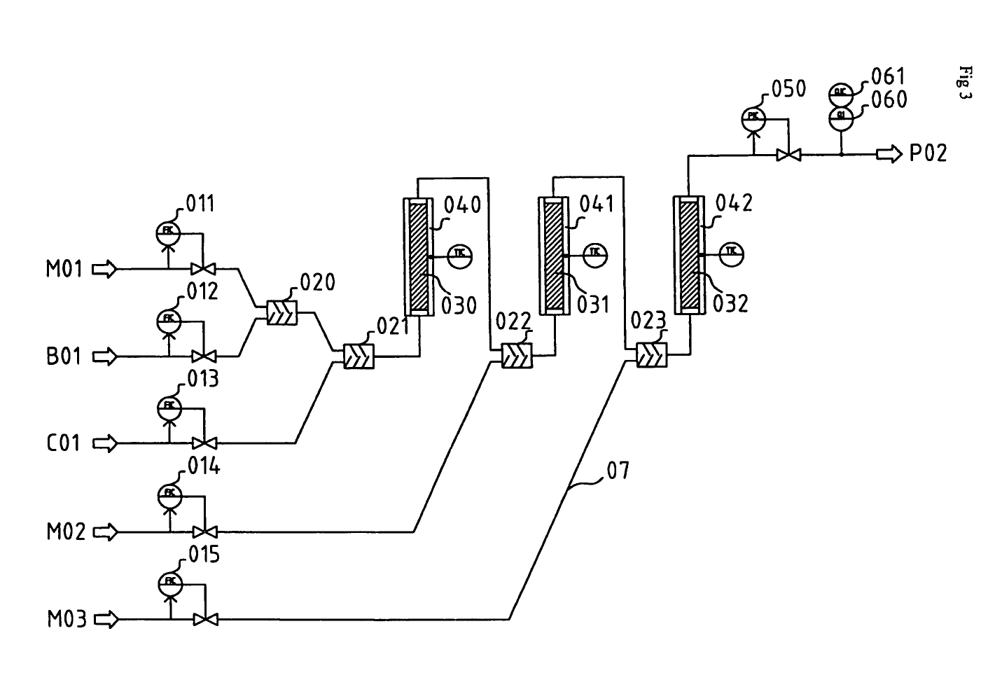

FIG. 3 shows a flow-chart with a serial arrangement of fixed bed reactors (030)-(032), and a stepwise addition of the monomer (see list of reference numerals at the end of the Examples).

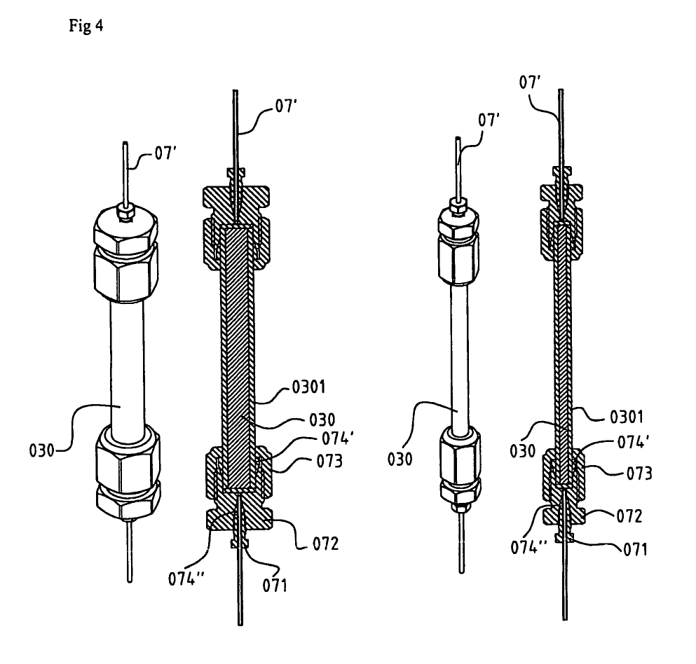

In FIG. 4 two possible embodiments of reactors (030) are shown which can be employed for the method according to the invention, whereby for each individual reactor of these reactors an overview drawing and a sectional drawing are illustrated. The reactor, which is presented in FIG. 2 on the left side, has a lower ratio of length to diameter than the reactor on the right side. For the reactors (030), which are presented in FIG. 4, the reactor pipes (0301) are, for example, connected via screw connecting parts (071, 072, and 073) with pipe sections (07′), wherein the screw connections are sealed with sealings (074′ and 074″).

The dead volume of such a reactor is small. The reactor embodiment of FIG. 4 is analogous to a HPLC-column.

When carrying out polymerization reactions, in principle, the risk exists that the reactor may get clogged, provided the reaction takes place beyond the suitable reaction parameters. This may happen in the process optimization of known reactions or also in the realization of reactions not recorded until yet, in which, for example, the viscosity properties of the generated products cannot be properly estimated. The clogging of the reactor, which may occur in an uncontrolled formation of polymers, however, is not critical because the optimization of the reaction process at first can be carried out by using a low cost bed. In a continuous operation it is conceivable to work with a structured, considerably more expensive reactor respectively bed. It is to be recognized that the method according to the invention can be flexibly used.

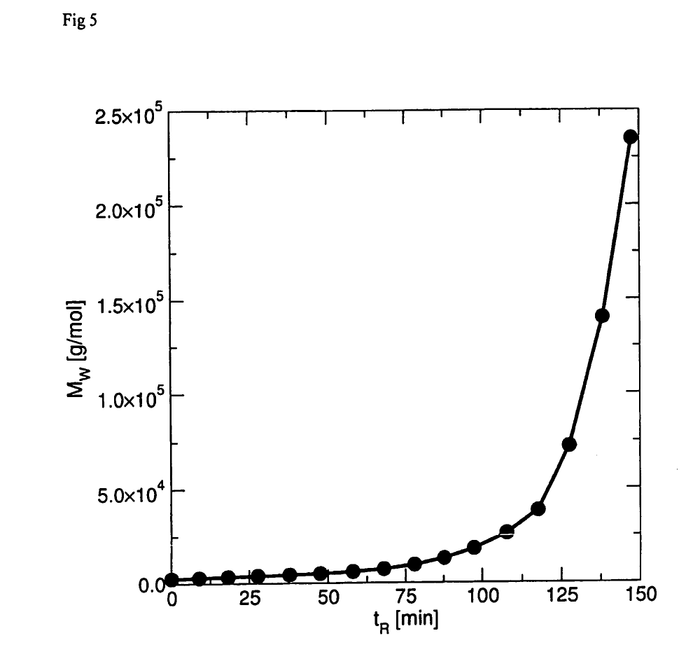

In FIG. 5 a typical reaction course in the batch mode is illustrated. With proceeding reaction time, the molecular weight of the produced polymer strongly increases (up to approximately 250,000 g/mol in the presented example). Thereby, the problem results therein to terminate the reaction in the appropriate moment in order to precisely obtain the desired molecular weight. If the reaction is stopped to early, then the molecular weight is too low, is the reaction terminated too late, the molecular weight is too high. In both cases, the polymer cannot longer be processed as intended. By means of the steep (exponential) increase of the molecular weight within this range, it is very difficult to determine the appropriate stop moment, because in the batch operation no adequate online chemical analysis is present.

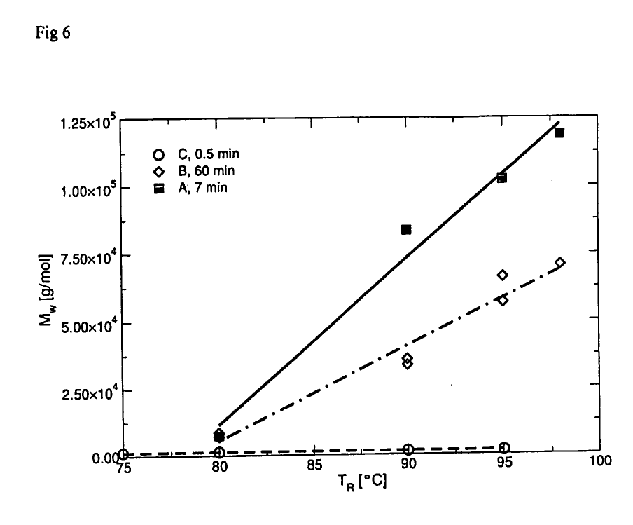

In FIG. 6 the experimental data are presented, which were obtained in a polymerization reaction by means of capillary reactor (prior art) and by means of FBR according to the invention. In these experiments, the residence times and the reaction temperature were varied. It can be recognized that in the capillary reactor at very small residence times (0.5 min.) only very small molecular weights of polymer are achieved. When drastically increasing the residence time in the capillary reactor up to 60 min (by extension of the capillary and smaller volume feeds) a significant increase of the molecular weight can be achieved. At a reaction temperature of 98° C., molecular weights up to approximately 75,000 g/mol can be achieved (determined by GPC). On contrary, the FBR according to the invention works essentially more efficient: at a residence time of only 7 min essentially higher molecular weights are achieved as compared to the capillary reactor at 60 min. At a reaction temperature of 98° C., a molecular weight of approximately 120,000 g/mol is achieved. Furthermore, strong dependence of molecular weight from the temperature can be seen: increasing temperature results in a significant increase of the molecular weight. Without being bound to a certain mechanism, it has to be concluded that the fixed bed reactor therefore works more efficient because the mass transport between organic and aqueous phase is intensified.

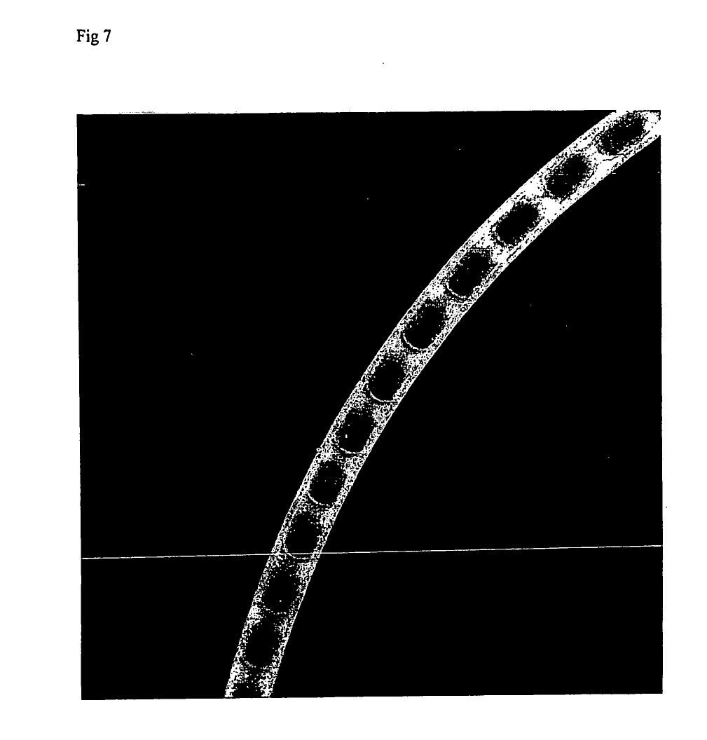

FIG. 7 shows the flow characteristic in the capillary at the outlet of the reactor. The photo shows the multi-phase flow of the reaction partners in a PTFE-capillary/transfer pipe after the flow of bulk materials reactor. One realizes the typical behaviour for a multi-phase flow in a capillary, the so-called Taylor-Flow-Regime. The aqueous phase can be recognized as the dark region, the organic phase as the bright region (“packets”). The inner diameter of the PTFE capillary is 0.8 mm. This form of a multi-phase flow in the capillary (above all the constancy) can only be achieved if in the FBR the two non-miscible liquid phases are well-mixed with each other. The separation into the packets, which can be recognized in the photo, furthermore occurs only in the capillary.

The photo therewith evidences the good phase mixing in the reactor. If in the FBR a phase separation would occur, the plugs/packets of organic and aqueous phase at the reactor outlet would be essentially larger and more irregular. The flow picture corresponds in principle to the flow picture, which is achieved in a capillary having the same diameter directly after a micro-mixer.

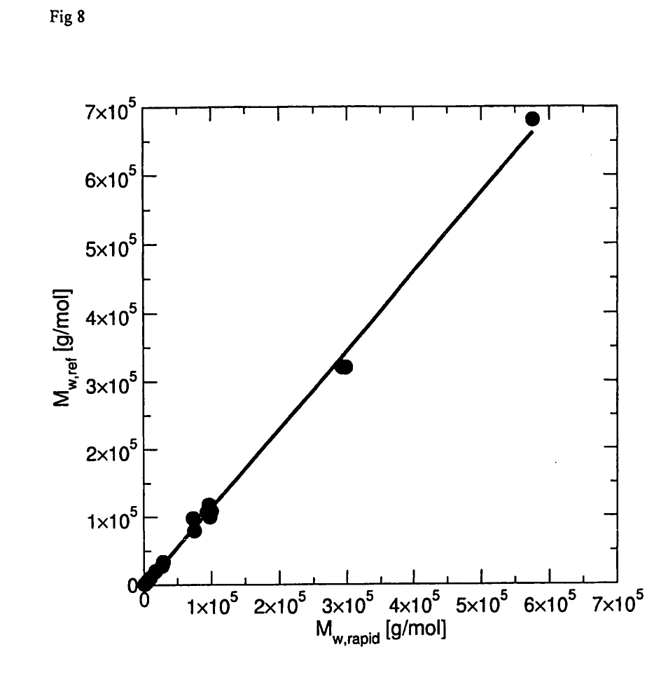

FIG. 8 shows that rapid GPC is a suitable instrument for the online analysis of polymerization reactions. Thereby, the results being obtained by means of conventional GPC (duration approximately 30 min per analysis) for the molecular weight (“ref”) are plotted versus the molecular weights (“rapid”) being obtained by means of rapid GPC (duration per analysis approximately 6 min). The linear course confirms the equivalence of both methods.

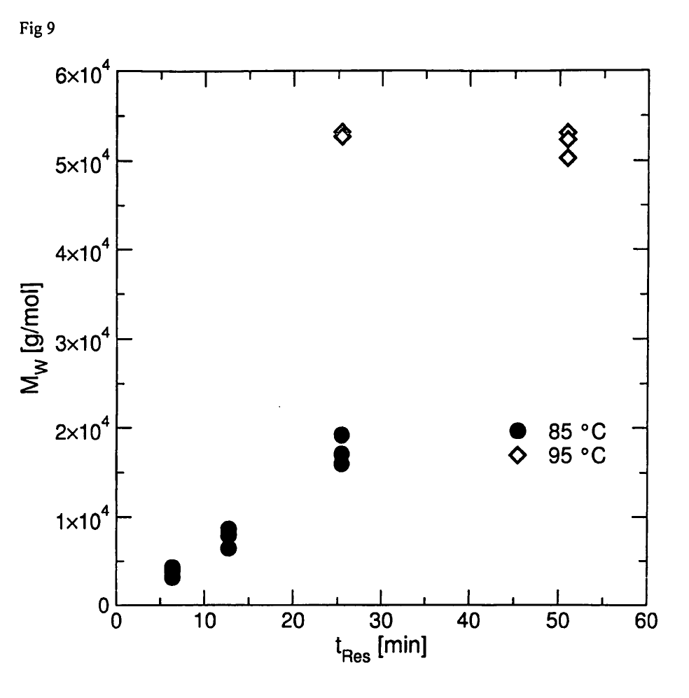

FIG. 9 shows the molecular weight (average weights) of the polymer product, which was obtained by using the capillary reactor as described in Example 5. This capillary reactor corresponds to the reactors of the prior art as they typically are employed for coupling reactions of the type as described in Example 5. The particularly long residence times according to embodiment Example 5 are achieved by means of the choice of a particularly long capillary reactor. Thereby, extremely long residence times up to 60 min are achievable. Despite these long residence times, however, the achievable molecular weight is limited to approximately 5×10⁻⁴ g/mol. Therewith, this comparison example and the corresponding figure illustrate particularly clear that in the conventional operation mode by using conventional capillary reactors the molecular weight for the coupling reactions is clearly limited upwards.

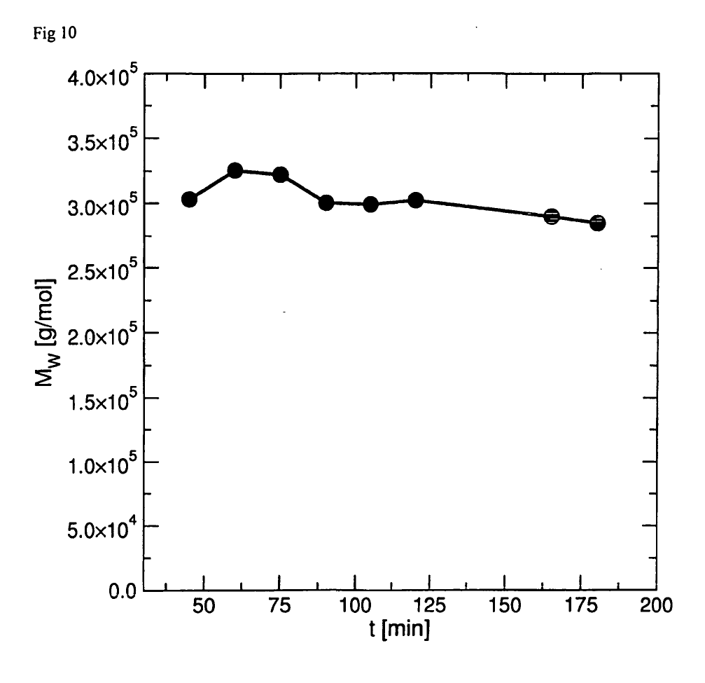

FIG. 10 illustrates on the other hand that in a reactor according to the invention (as described in Example 6) molecular weights up to 3×10⁵ g/mol are obtainable, and indeed constantly over a long operation period. The monitored operation period according to FIG. 10 corresponds to three hours. As can also be taken from FIG. 10, the molecular weight is constant as far as possible over this long period of continuous operation. Thus, FIG. 10 does not only illustrate that by using the method according to the invention and the employment of the fixed bed reactor that was for the first time described for these coupling reactions not only particularly high molecular weights are achievable, as is desired for the application, however that these high molecular weights can also be produced over a long period with constant quality in continuous operation.

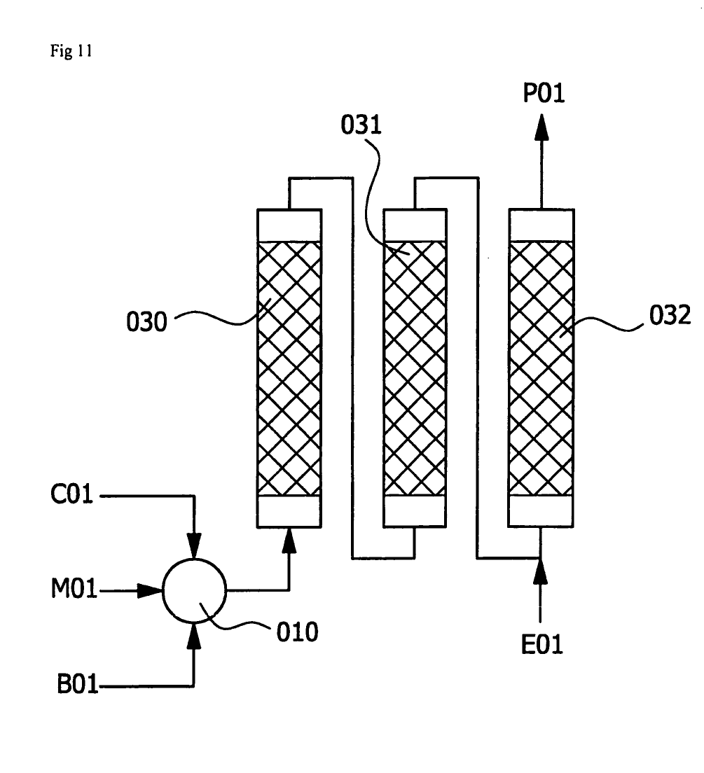

FIG. 11 illustrates the flow-chart for a connection of three fixed bed reactors according to the invention, wherein these reactors are connected in series. According to a preferred embodiment of the present invention, as illustrated in FIG. 11, at least two reactors having fixed beds with bulk materials (030, 031) are connected in series, in order to increase the residence time of the educt, respectively of the educts in the reactor. Thereby, it is preferred that these at least two reactors are provided with a mixture of at least one catalyst C01, at least one monomer M01 and at least one base B01, which were mixed in a micro-mixer (010).

According to the embodiment, which is shown in FIG. 11, it is further preferred that the product which emanates from the second reactor (031) is fed to a further reactor having fixed bed (032) together with an endcapper E01 in continuous operation. Thereby, the endcapper E01 has the function to saturate at least one functional group of the polymer product, respectively of the monomer still being present, and therewith to control the molecular weight. The possibly not saturated further end group can be separately treated during the product processing.

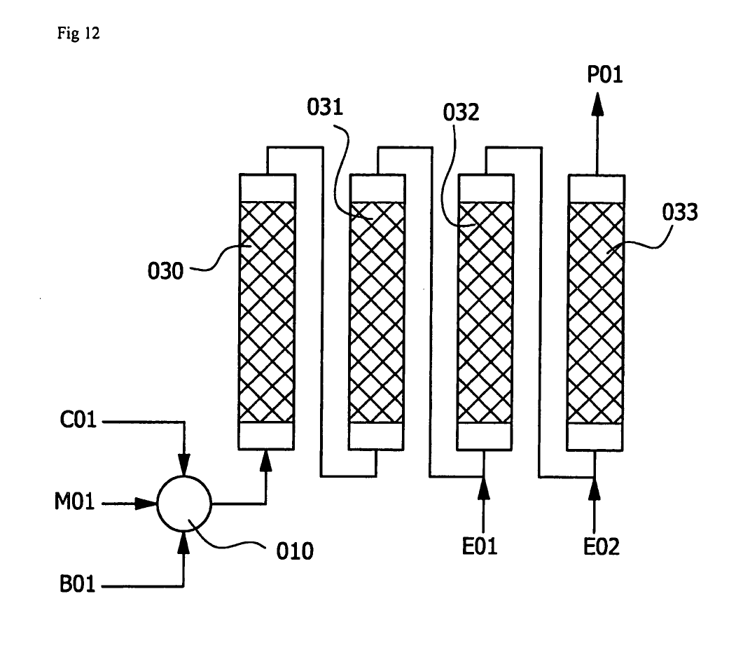

FIG. 12 shows a further development of the device of FIG. 11, wherein assembly and process guidance up to the reactor (032) are identical to the arrangement described in connection with FIG. 11. In completion to the arrangement described in FIG. 11, however, the product which emanates from the third reactor (032) is reacted in a fourth reactor (033) with a second endcapper E02, thereby also saturating the other end group in the continuous operation.

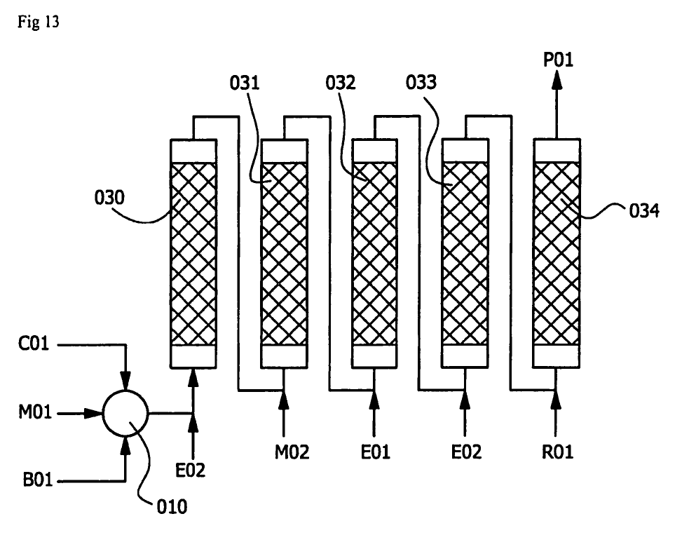

FIG. 13 shows the flow-chart for the continuous manufacture of a polymer from a multitude of monomers (preferably from at least two different monomers) in a particularly versatile arrangement, which corresponds to a preferred embodiment of the present invention. According to this preferred embodiment, at least five reactors (030) to (034) are present which are serially connected. Thereby, in the first reactor (030) preferably a mixture is fed from a micro-mixer (010), which at least consists of a catalyst (C01), at least one monomer (M01) and at last one base (B01). Separated from or together with the feed of the mixture from micro-mixer (010), an endcapper (E02) can be already added to the first reactor (030).

The embodiment shown in FIG. 13 allows the manufacture of block-(co-)polymers, and namely thereby that a second monomer (M02) is fed to the polymer product from the first reactor (030) in a second reactor (031). Then, this second monomer reacts with the already polymerized monomer (M01) from the first reactor and thus results in the formation of block polymers. The termination of the polymerization reaction preferably occurs in two reactors (032) and (033) which are connected downstream, to each of which is fed an endcapper (E01) and (E02) for one of the both end groups, respectively.

According to a further preferred embodiment, the catalyst is neutralized respectively reacted in a fifth reactor (034) which is downstream of the reactor (033), and namely by addition of means (R01) for the deactivation of the catalyst, for example by addition of carbamide. Thus, the final product block polymer (P01) emanates at the head of the fifth reactor (034).

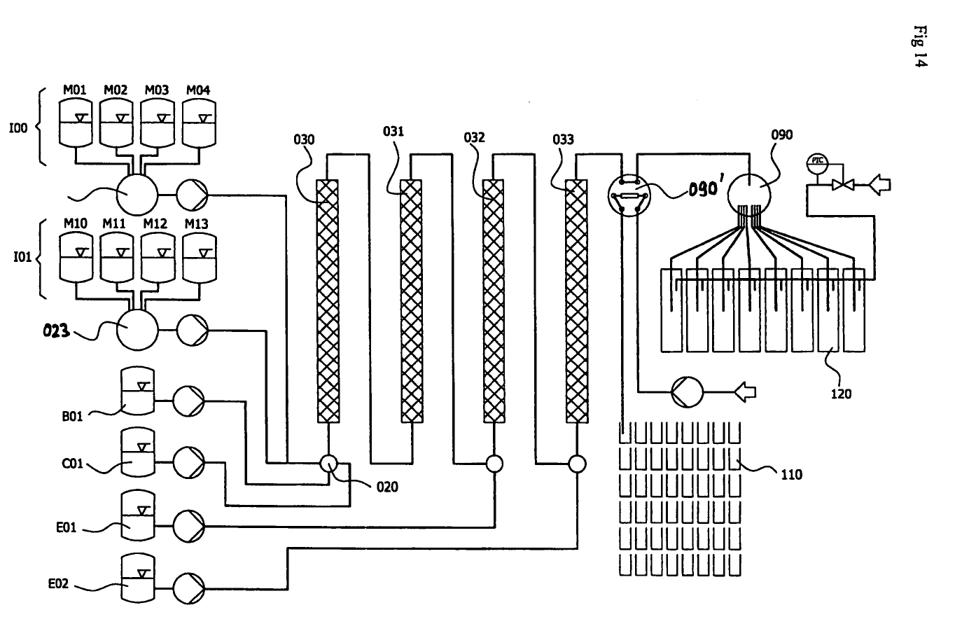

Finally, FIG. 14 shows the flow-chart for a device for the sequential synthesis of at least two different polymers and/or block copolymers. According to this preferred embodiment, at least two different monomer receivers (100) and (101) are present. Preferably, each monomer receiver contains at least one, however, preferably more than two different monomers.

Further preferred, the monomers (M01, M02, . . . ) of the monomer receiver (100) each have the same functional group, however, differ in physical and/or chemical manner from each other. Thereby, it is further preferred that the monomers (M10, M11 . . . ) of the at least one further monomer receiver (101) have another functional group compared to the monomers of the first monomer receiver (100).

If per monomer receiver two or more different monomers should be present, then these may optionally be mixed in a mixer (023) prior to the feeding to a reactor. Different monomers from two different monomer receivers (100) and (101) may be mixed prior to the feeding to a reactor also in a micro-mixer (020) and/or with further components from the corresponding receivers, for example with a base (B01) and/or a catalyst (C01). Also the addition of an endcapper (E01) is possible at this moment.

Thereby, it is particularly preferred that for the manufacture of block polymers at least one monomer from at least one monomer receiver is fed to at least one reactor, whereas at least one further monomer that is different from the first monomer is fed into a reactor which is downstream of the first reactor (not presented in the Figure).

With respect to number, type and arrangement of reactors (030) to (033), which are connected in series, no restrictions exist in the context of the device for the sequential synthesis of different polymers, which is described herein. This particularly applies with respect to the employment of fixed beds having bulk materials and the continuous operation with regard to at least two non-miscible liquid phases. Concerning this matter, reference is made to the before-described disclosure of the whole application.

At the outlet of the last reactor of the device for the sequential synthesis of polymers, preferably a multiport valve (090) is provided, which preferably has a sample loop (090′) for the taking of samples.

The device for the sequential synthesis of polymers which is described in the present embodiment preferably comprises also positioning means by means of which many different samples of a pre-determined quantity can be sequentially taken. Thereby, preferably an assembly (library of samples) (110) is produced.

It is further preferred that a product collection in larger containers (120) can be separately taken via multiport valve (090) which are suitable for a later product processing and for a further use of the product.

Further preferred, the device for the sequential synthesis of polymers has at least one pressure control and/or at least one flow control and/or at least one temperature control (in FIG. 14 only the pressure control is presented).

Since the device described before for the sequential synthesis of polymers can be high-gradely automated, this device is particularly suitable for the manufacture of a multitude of different polymer samples, which can be continuously monitored. Thereby, in particular, the stability of the molecular weight and the possibility to be able to set-up many parameters are advantageous for the manufacture of a multitude of different, well characterized polymers.

### EXAMPLES

The following examples are intended to exemplarily illustrate the method according to the invention at hand of concrete embodiments. Thereby, the continuous method according to the invention (Example 4) is compared with the batch-method (Example 1) known from the prior art as well as with methods using capillary reactors (Examples 2 and 3). Since the examples have only illustrative character, they can neither completely describe the present invention nor restrict this invention to the concrete embodiments. The coupling reactions mentioned in the examples correspond to the following scheme:

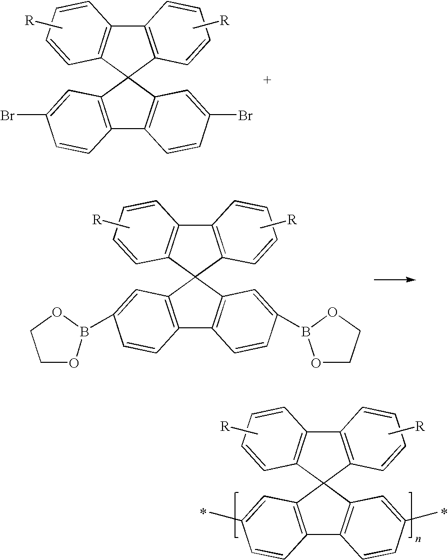

No restrictions exist with regard to the residues R, which may be the same or may be different.

The conversion with regard to polymer, which is given in the presented examples is only exemplary. The conversion can be in the range of from 10 g/h to 10 kg/h, preferably 100 g/h to 1 kg/h.

### Example 1

### Comparison Example

### Operation in Batch-Mode

For the reaction, a dioxane/toluene mixture having 0.1 mol-% Pd (c=1·10⁻⁴ mol/L) is provided. As reaction the copolymerization of 50 mol-% bisboric acid ester (M1) and 50 mol-% bisbromide (M2) is carried out.

4.003 g (5 mmol) M1, 4.094 g (5 mmol) M2, 5.066 g (10 mmol) K₃PO₄.H₂O are dissolved in 100 ml toluene/dioxane mixture and 50 ml water and are inerted by passing argon or nitrogen for 30 min through this mixture. The solvent is heated under inert gas up to 87° C. internal temperature, and subsequently 2.2 mg (10 μmol) palladium acetate and 9.1 mg (60 μmol) tris-(o-tolyl)phosphine dissolved in 1 ml of the solvent mixture are added. The reaction mixture is heated in the batch mode for two hours under reflux until the desired viscosity is achieved.

### Examples 2 to 4

### Continuous Method for Manufacture

Each of the Examples 2 to 4 is based on the same composition: dioxane/toluene mixture having 0.4 mol-% Pd; copolymerization of 50 mol-% bisboric acid ester (M1) and 50 mol-% bisbromide (M2).

Monomers M1 and M2, base (K₃PO₄.H₂O) and catalyst (palladium acetate and tris-(o-tolyl)phosphine) are provided in separated supply containers, and are subsequently freed from oxygen by passing argon or nitrogen for 30 min through the mixture. Preferably, for inerting, helium is employed because this has a lower solubility in gas. Monomer and catalyst are dissolved by addition of inerted dioxane/toluene mixture, and the base by addition of inerted water. Thus, an organic solvent phase and an aqueous phase having base not being miscible with the organic phase coexist. HPLC or syringe pumps transport the respective educts with a defined volume flow. At first, the educt flows are continuously mixed in a micro-mixer. Subsequently, the reaction (T=70-120° C. and p=5-10 bar) is carried out in the respective reactor given in the example. The taking of the sample subsequently follows.

With regard to the employed base, no restrictions exist according to the invention. As preferred bases, K₃PO₄, tetraethylammonium hydroxide, NaOH, KOH or KF are employed. As concentration of the base, 2 to 7 mole equivalents K₃PO₄ per mole employed monomer is preferred.

### Example 2

### Comparison Example

### Capillary Reactor without Fixed Bed

Monomers: 50 mol-% M1, 50 mol-% M2
   c=0.08 mol/L
   V=0.0547 ml/min
Base: 2.2 equivalents K₃PO₄
   c=0.352 mol/L
   V=0.0391 ml/min
Catalyst: 0.4 mol-% Pd(OAc)₂, 2.4 mol-% P(o-tolyl)₃
   c=3.2·10⁻⁴ mol/L Pd(OAc)₂, c=1.92·10⁻³ mol/L P(o-tolyl)₃
   V=0.0235 ml/min
Reactor: Capillary reactor: 3,000 mm length×Ø0.15 mm
   τ=0.5 min (residence time)

### Example 3

### Comparison Example

### Capillary Reactor without Fixed Bed

Monomers: 50 mol-% M1, 50 mol-% M2
   c=0.08 mol/L
   V=0.0547 ml/min
Base: 2.2 equivalents K₃PO₄
   c=0.352 mol/L
   V=0.0391 ml/min
Catalyst: 0.4 mol-% Pd(OAc)₂, 2.4 mol-% P(o-tolyl)₃
   c=3.2·10⁻⁴ mol/L Pd(OAc)₂, c=1.92·10⁻³ mol/L P(o-tolyl)₃
   V=0.0235 ml/min
Reactor: Capillary reactor: 14,000 mm length×Ø0.8 mm
   τ=60 min (residence time)

### Example 4

### Continuous Operation in the Fixed Bed Reactor According to the Invention

Monomers: 50 mol-% M1, 50 mol-% M2
   c=0.08 mol/L
   V=0.0547 ml/min
Base: 4.4 equivalents K₃PO₄
   c=0.704 mol/L
   V=0.0391 ml/min
Catalyst: 0.4 mol-% Pd(OAc)₂, 2.4 mol-% P(o-tolyl)₃
   c=3.2·10⁻⁴ mol/L Pd(OAc)₂, c=1.92·10⁻³ mol/L P(o-tolyl)₃
   V=0.0235 ml/min
Reactor: Stainless steel tube reactor: 250 mm length×Ø3.2 mm
Steatite bulk in fixed bed (particle size 160 to 250 μm)
τ=7 min (residence time)

The results are presented in FIG. 6. There, the weight-averaged molecular weight M_{w} of the produced polymer (in units of g/mol) is presented as function of the reactor temperature (in degree Celsius). It is clearly apparent that the short capillary reactor (open circles) without fixed bed according to Example 2 with the accordingly lower residence time (RT) does not result in a noteworthy polymerization, which is in fact desired. The longer capillary reactor according to Example 3, which also does not contain a fixed bed (open rhombs) having a twelvefold longer RT in fact achieves molecular weights of some ten thousand, however considerably lower molecular weights than the fixed bed reactor according to the invention (filled squares) according to Example 4, which furthermore has a considerably lower, i.e., cost-effective RT.

### Example 5

### Comparison Example with Capillary Reactor without Fixed Bed with Particularly Long Residence Time

Monomers: 50 mol-% bisboric acid ester, 50 mol-% bisbromide
   c=0.08 mol/L
   m=23.1 g/h (or V=0.4052 ml/min)
Base: 5.5 equivalents K₃PO₄
   m=17.4 g/h (or V=0.29 ml/min)
Catalyst: 0.2 mol-% Pd(OAc)₂, 1.2 mol-% P(o-tolyl)₃
   m=9.9 g/h (or V=0.17 ml/min)
Solvent: toluene:dioxane:THF=1:1:1
Reactor: L=22,000 mm, ID=0.8 mm PTFE capillary reactor
Reaction conditions:
   85° C. reaction temperature
   from sample 4: 95° C. reaction temperature
   5 bar reaction pressure
   50° C. sample drawing temperature
   ˜25.5 min residence time, from sample 7: ˜51 min residence time at ½ total volume flow

From this comparison example (see also FIG. 9) results that also at higher residence times (up to one hour) the maximum achievable molecular weight is limited. If higher molecular weights higher than 5×10⁻⁴ g/mol are to be achieved, this continuous operation is not longer suitable.

### Example 6

### Continuous Operation in Fixed Bed According to the Invention

Monomers: 50 mol-% bisboric acid ester, 50 mol-% bisbromide
   c=0.08 mol/L
   m=23.1 g/h (or V=0.4052 ml/min)
Base: 5.5 equivalents K₃PO₄
   m=17.4 g/h (or V=0.29 ml/min)
Catalyst: 0.2 mol-% Pd(OAc)₂, 1.2 mol-% P(o-tolyl)₃
   m=9.9 g/h (or V=0.17 ml/min)
Solvent: toluene:dioxane:THF=1:1:1
Reactor:
   R1: L=250 mm, ID=9.4 mm stainless steel reactor, 70-110 μm silica sand
   R2: L=250 mm, ID=9.4 mm stainless steel reactor, 70-110 μm silica sand
Reaction conditions:
   85° C. reaction temperature
   5 bar reaction pressure
   50° C. sample drawing temperature
   ˜17.4 min residence time
Throughput: approximately 1.5 g polymer per hour

As apparent from FIG. 10, in this operation mode molecular weights of 3×10⁵ g/mol can be achieved, and in fact already after an average residence time of approximately 17 min. As also apparent from FIG. 10, such high molecular weights can be constantly achieved over a long period (here: at last 200 minutes).

### LIST WITH REFERENCE NUMERALS

M01, M02, . . . —monomer 1, 2, . . .
B01—base
C01—catalyst
E01, E02—endcapper
P01—polymer
R01— means for deactivating the catalyst
S01, S02, . . . —solvent 1, 2, . . .
G01—inert gas
010—mixer
011-015—mass flow controller
020, 023—micro-mixer
030-034—fixed bed reactor
040-042—heater
050—pressure controller
060, 061—device for online analysis
07—piping
07′—pipe section
080-085—pumps 1 to 5
090—multiport valve with sample loop
91-93—valves
10 mixer
0301—reaction tube
071-073—screw coupling parts
074′, 074″—sealings
100, 101—monomer receivers
110—library of different polymer samples
120—product collecting receiver

1-19. (canceled)

20. A process for the continuous reaction of at least two liquid phases that are not miscible with each other, comprising:
(i) combining at least two liquid phases that are not miscible with each other, in a defined relative ratio of quantity;
(iii) feeding the mixture from (i), or from a step following step (i), into a fixed bed reactor, which is flowed through by this mixture for a determined residence time at a defined temperature, wherein a fixed bed reactor is a reactor, which at least comprises one means for the mass transfer between two non-miscible phases,
wherein the process is employed for at least one coupling reaction between at least two (hetero)aryl compounds, including aryl-aryl coupling, aryl-heteroaryl coupling, and heteroaryl-heteroaryl coupling, wherein the two compounds may be the same or different.

21. The process of claim 20, wherein the combination of step (i) takes place in at least one mixing point.

22. The process of claim 21, wherein the at least one mixing point is developed such that after said mixing point said at least two non-miscible phases exist in a capillary in the form of separated packets or droplets, wherein said packets or droplets exist in a length or a diameter that is/are not more than thrice as high as the capillary diameter, preferably not more than twice as high, further preferred not more than just as high as the capillary diameter.

23. The process of claim 20, wherein the fixed bed reactor is developed such that after the outlet of the fixed bed reactor at least two phases that are not miscible with each other, emanating from the reactor exist in a capillary in the form of separated packets or droplets, wherein said separated packets or droplets exist in a length or a diameter that is/are not more than thrice as high as the capillary diameter, preferably not more than twice as high, further preferred not more than just as high as the capillary diameter.

24. The process of claim 20, further comprising step (ii):
(ii) feeding the mixture from (i) to a mixer in which an at least partially mixing of said at least two non-miscible liquid phases takes place,
which is carried out between steps (i) and (iii).

25. The process of claim 20, further comprising step (iv):
(iv) feeding at least one phase of the at least two phases effusing from the fixed bed reactor from (iii) to a device for online analysis,
which is carried out after step (iii).

26. The process of claim 25, wherein a solvent is metered to the phase to be analyzed.

27. The process of claim 20, wherein the fixed bed reactor is a bulk materials reactor containing a bed of particles, preferably of spherical particles, further preferred of spherical particles having a diameter of from 1 μm to 2,000 μm, preferably of from 50 μm to 500 μm.

28. The process of claim 20, wherein the process serves for the reaction of a halide-functional or sulfonyl oxy-functional aryl or heteroaryl compound with an aromatic or heteroaromatic boron compound, preferred in the presence of a catalyst as well as in the presence of a base and a solvent or a mixture of solvents, wherein an aryl-aryl-C—C-bond, an aryl-heteroaryl-C—C-bond or a heteroary-heteroaryl-C—C-bond is formed.

29. The process of claim 28, wherein at least one coupling reaction is a Suzuki-coupling.

30. The process of claim 28, wherein as at least one starting component in at least one of the at least two liquid phases a monomer is employed, which then reacts in a multitude of coupling reactions to at least one polymer.

31. The process of claim 20, wherein the control of the method is carried out by means of an online chemical analysis, which is downstream of the fixed bed reactor.

32. The process of claim 24, wherein in step (ii) a static micro-mixer is employed, preferably at least two of said static micro-mixers in a serial connection.

33. The process of claim 32, wherein a multi-step mixing method is carried out, in which at first several two-component mixtures are generated, which are subsequently combined in or before the fixed bed reactor.

34. The process of claim 20, wherein the fixed bed reactor is tube-shaped and has an inner diameter that is in the range of from 1 to 50 mm, preferably in a range of from 1 to 20 mm, further preferred in a range of from 1 to 10 mm.

35. The process of claim 20, wherein the residence times of individual volume segments of the material flow in the fixed bed reactor are between 1 and 150 min, preferably between 1 and 60 min, further preferred between 1 and 30 min.

36. The process of claim 30, wherein, as method for the online analysis, gel permeation chromatography (GPC) is employed.

37. The process of claim 20, wherein said at least two non-miscible liquid phases flow through the fixed bed reactor from the bottom-up.

38. The process of claim 20, further comprising at least one of the following steps: (a) heating the reactor, preferably stepwise heating the reactor, further preferred in different heating zones along the flow direction with different temperature; (b) reaction stop by cooling after the reactor outlet; (c) addition of endcappers after the reactor outlet; (d) addition of solvent for reducing viscosity after the reactor outlet; (e) addition of further monomers after each reactor section; (f) series connection of several reactors; (g) parallel connection of several reactors for increasing the throughput.
